(19) United States
(12) Patent Application Publication
(10) Pub. No.: US 2018/0075824 A1
(43) Pub. Date: Mar. 15, 2018

(54) MODULAR DOUBLE NECK ELECTRIC INSTRUMENT

(71) Applicant: Scott Neil Gorsuch, Columbus, OH (US)

(72) Inventor: Scott Neil Gorsuch, Columbus, OH (US)

(21) Appl. No.: 15/265,043

(22) Filed: Sep. 14, 2016

(51) Int. Cl. G10D 1/08; G10D 3/06

(52) U.S. Cl. CPC G10D 1/08; G10D 3/06; G10D 1/085

(57) ABSTRACT

A modular double neck electric instrument having a host instrument and a satellite instrument is provided. Each instrument being movable between a separate condition as two separate operable instruments and a nested condition as one two-necked instrument physically and electrically connected. The physical and electrical connections interfacing across complementary receiving and engaging surfaces provided by the respective instrument bodies, wherein the physical connection includes lateral and axial connections and wherein the electrical connection include spring-loaded conductors for maintaining flush receiving and engaging surfaces that engage in the nested condition.

### BACKGROUND OF THE INVENTION

The present invention relates to musical instruments and, more particularly, a modular double neck electric instrument.

When a guitarist is playing a song, which requires them to play both a 6 string guitar and a 12 string guitar, he/she must put one instrument down, and pick up the other. Currently, other modular double neck guitars use bolts to hold them together. Bolted-together modular double necks, however, require tools, and several minutes to attach/detach, thus causing delays between 6-string songs and 12-string songs, and making the playing songs requiring both 6-strings and 12-string guitar playing by the same guitarist prohibitively unentertaining.

As can be seen, there is a need for a modular double neck electrical instrument enabled to physically and electrically connect or disconnect without having to use tools to manipulate fasteners, becoming either two separate one-neck stringed electrical instruments or one double-neck stringed electric instrument between songs, and even in the middle of one.

### SUMMARY OF THE INVENTION

In one aspect of the present invention, a modular double neck electric instrument includes a host musical instrument having a host body, the host body forming a receiving surface along a portion of its periphery; a satellite musical instrument having a satellite body, the satellite body forming an engaging surface along a portion of its periphery, wherein the engaging surface complements the receiving surface so as to interface in a nested condition; a physical connection including a lateral connection; and an axial connection spaced apart from the lateral connection, wherein the physical connection is provided along the receiving and the engaging surface; and an electrical connection provided along both the receiving and the engaging surface so as to not protrude from either surface in the nested condition, whereby the host musical instrument and the satellite musical instrument are movable between the nested condition and a separate condition without tools, and in each condition the musical instruments are musically playable.

In another aspect of the present invention, the modular double neck electric instrument includes a host musical instrument having a host body, the host body forming a receiving surface along a portion of its periphery, wherein the receiving and engaging surfaces are complementary concave and convex J-shapes, respectively; a satellite musical instrument having a satellite body, the satellite body forming an engaging surface along a portion of its periphery, wherein the engaging surface complements the receiving surface so as to interface in a nested condition; a physical connection including a lateral connection comprising least one pin and at least one complementary pin cavity, each disposed on opposing surfaces of the receiving and engaging surface and aligned in the nested condition; and an axial connection spaced apart from the lateral connection, wherein the physical connection is provided along the receiving and the engaging surface, the axial connection including a magnet and a ferromagnetic element, each disposed on opposing surfaces of the receiving and engaging surface and aligned in the nested condition; an electrical connection provided along both the receiving and the engaging surface so as to not protrude from either surface in the nested condition, the electrical connection including: at least one first conductor spring loaded in a receptacle to protrude therefrom; and at least one complementary second conductor, wherein each first and complementary second conductors is disposed on opposing surfaces of the receiving and engaging surface, aligned, and electrically connected in the nested condition; a strap button provided on the engaging surface; and a button cavity provided on the receiving surface so as to operatively align with the strap button in the nested condition.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a detailed exploded rear view of an exemplary embodiment of the present invention;

FIG. 3 is a detailed exploded front view of an exemplary embodiment of the present invention;

FIG. 4 is a cutaway-section view of an exemplary embodiment of the present invention, taken along line 4-4 of FIG. 1;

FIG. 5 is a detailed section view of an exemplary embodiment of the present invention;

FIG. 6 is a detailed section view of an exemplary embodiment of the present invention; and

FIG. 7 is a detail section view of an exemplary embodiment of the present invention, taken along line 7-7 of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a modular double neck electric instrument having a host instrument and a satellite instrument, each movable between a separate condition as two separate operable instruments and a nested condition as one two-necked instrument physically and electrically connected. The physical and electrical connections interfacing across complementary receiving and engaging surfaces provided by the respective instrument bodies, wherein the physical connection includes lateral and axial connections and wherein the electrical connection include spring-loaded conductors for maintaining flush receiving and engaging surfaces that engage in the nested condition.

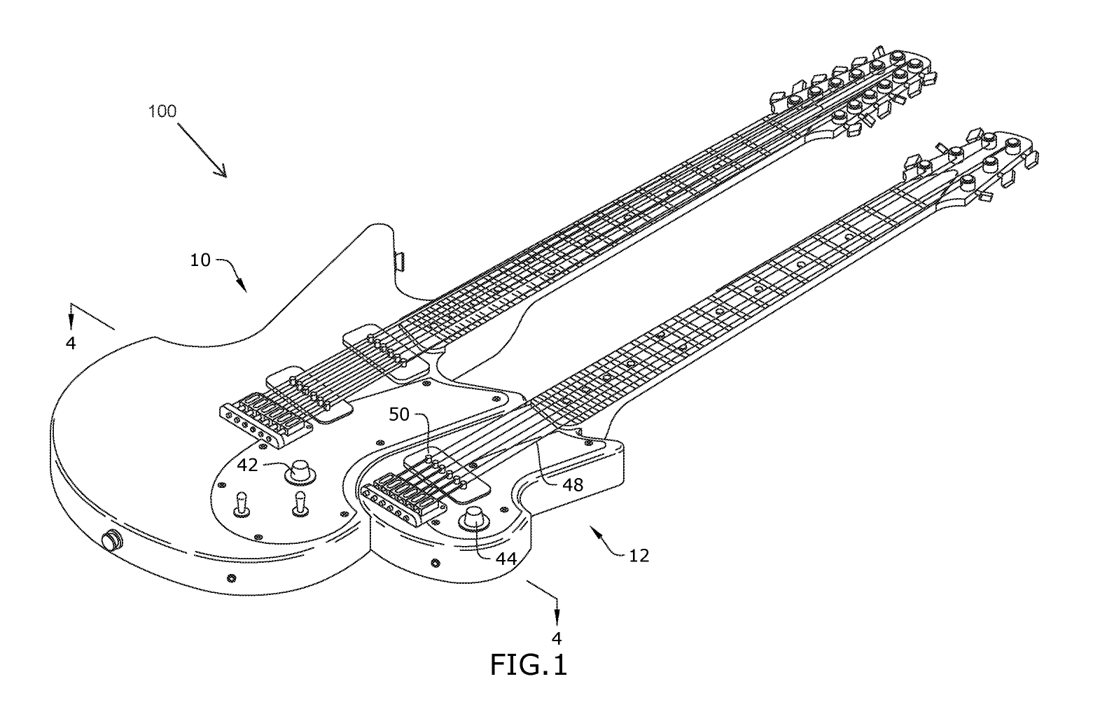

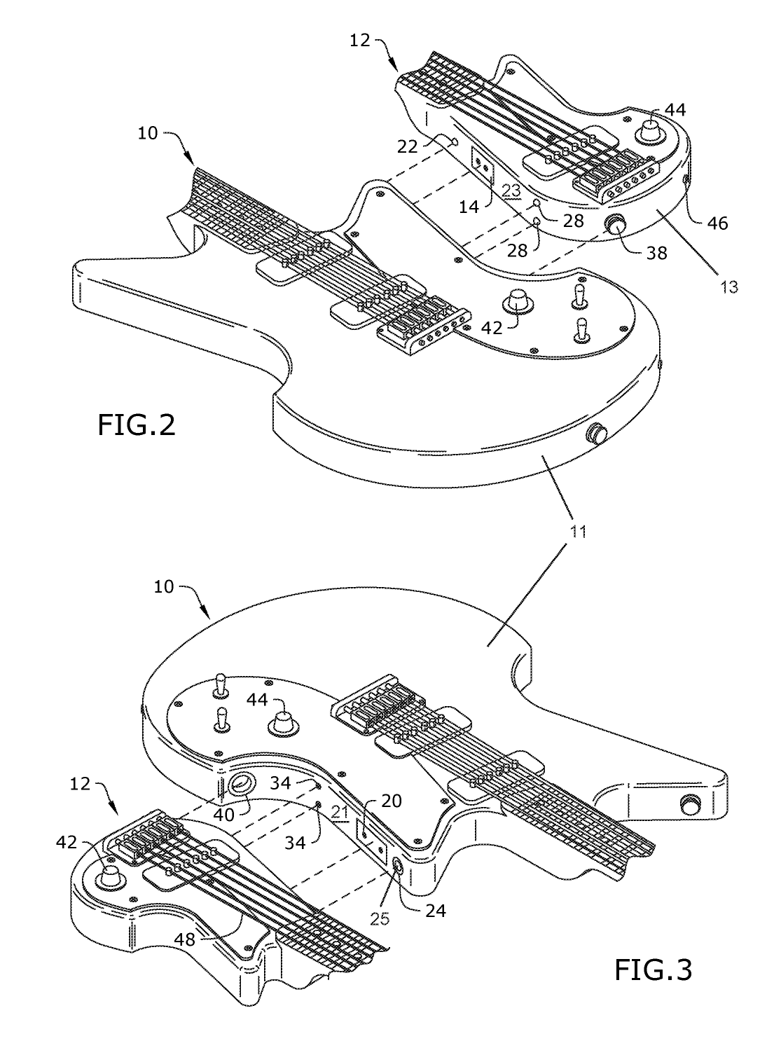

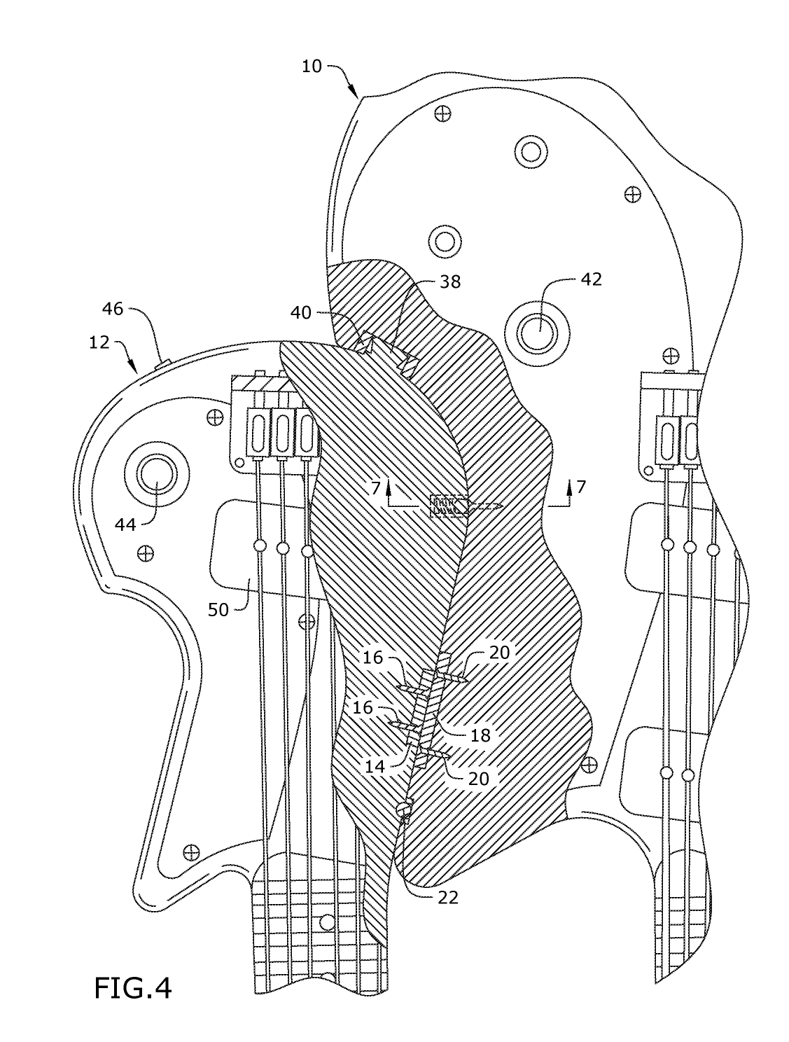

Referring now to FIGS. 1 through 7, the present invention may include a modular double neck electric instrument 100 having a host instrument 10 and a satellite instrument 12, each dimensioned and adapted to be removably coupled to each other by way of at least one removable physical connection and at least one removable electrical connection. In certain embodiments, the host and satellite instruments 10 and 12 may be electric string instruments, such as guitars, bass guitars or the like.

The host instrument 10 may be larger than the satellite instrument 12, but not in every embodiment. The body 11 of the host instrument 10 may form a receiving surface 21 that an engaging surface 23 of a body 13 of the satellite instrument may nest into when the two instruments are operatively coupled. Typically, such surfaces 21 and 23 are peripheral. It is understood that the bodies 11 and 13 of the two nested instruments may be partially defined by musical and/or aesthetic necessity, either as two separate instruments or when one coupled instrument. In certain embodiments, the engaging surface 23 may be a convex J-shape, while the receiving surface 21 may be concaved J-shape, as illustrated in FIG. 3.

Along either or both receiving and engaging surfaces 21, 23 may be provided at least one ferromagnetic element 18 and a strong magnet 14, respectively, so that when in the nested condition, the ferromagnetic element 18 and the strong magnet 14 align and mate. The ferromagnetic element 18 may be a metallic plate secured to its respective surface by fasteners 20, while the magnet 14 may be secured along its respective surface by magnet fasteners 16. It should be understood that in different embodiments, the magnet 14 could be disposed on the receiving or the engaging surface 21 or 23, with the ferromagnetic element 18 disposed athwart on the other opposing surface. The strong magnet 14 may be a neodymium magnet. The ferromagnetic element 18 and the strong magnet 14, when coupled, provide a removable axial force urging the two instruments to remain coupled.

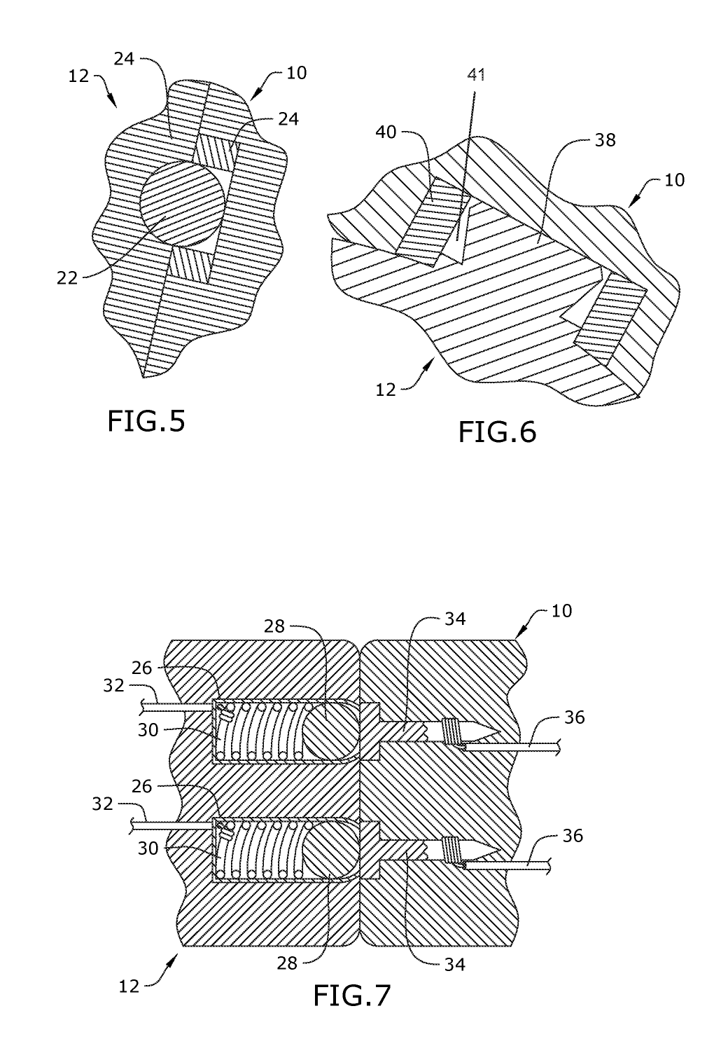

Lateral resistance to separation of the two nested instruments is provided by at least one lateral connection, such as a pin and socket connection. Along either or both receiving and engaging surfaces 21 and 23 may be provided at least one pin 22 and a complementary pin cavity 25, respectively, so that when in the nested condition, the respective pin 22 and pin cavity 25 nest and mate, resisting lateral movement of the two instruments relative to each other. The pin cavity 25 may provide a rigid material 24, such as brass or the like, sized and dimensioned snugly engage the pin 22 received within the pin cavity 25, wherein the rigid material provides stronger lateral resistance than that the body of the instrument, which may be compromised by musical or aesthetic necessities. In certain embodiments, the body of the instrument may form the pin cavity 25, wherein the rigid material 24 may be provided along a (circumferential) portion of said pin cavity 25, as illustrated in FIG. 5. It should be understood that in different embodiments, the at least one pin 22 could be on the receiving or the engaging surface 21 or 23, with the pin cavity 25 disposed athwart on the other opposing surface in the nested condition. In other embodiments, the at least one pin 22 may be an elongated long steel dowel pin, with its domed end protruding for engaging the complementary pin cavity 25, even though the FIG. 5 shows the pin 22 as a spheroid. In such embodiments, each elongated pin 22 may be about one inch in length.

Electrical connectivity between the two nested instruments may be provided by at least one first electrical conductor 28 and at least one complementary second electrical conductor 34, respectively, so that when in the nested condition, each complementary first and second conductors 28, 34 are electrically connected. Each electrical conductor 28, 34 may be any shape as long as they conduct electrical signal when electrically connected in the nested condition. In certain embodiments, the first conductor 28 may be a ball spring-loaded snugly within a receptacle 26 so as to slide along the circumferential walls of the receptacle 26, though where a spring 30 within the receptacle 26 urges the first connector 28 to protrude therefrom, as illustrated in FIG. 7. A first electrical wire 32 may be electrically coupled between the instrument and the first conductor 28, in certain embodiments, by way of the receptacle 26. The second conductor 34 may be a nail-shaped object, where the ‘nail head’ is flush with its respective receiving or engaging surface. A second electrical wire 36 may be electrically coupled between the respective instrument and the second conductor 34, so when the host and satellite instruments are in the nested condition, the two instruments are electrically connected. As illustrated in FIG. 7, in the nested condition the first conductor 28 may be urged into its receptacle 26 so as to not protrude therefrom yet be biased by the spring 30 to be flush with its respective receiving or engaging surface as it contacts its complementary second conductor 34, ensuring a flush engagement of said surfaces. It should be understood that in different embodiments, each first conductor 28 could be on the receiving and/or the engaging surface 21, 23, with its complementary second conductor 34 disposed athwart on the other opposing surface in the nested condition.

Mindful that in a separated condition, one or both of the instruments may have a strap button 38 for supporting a shoulder strap (not shown) that the user may sling over their shoulder, either the receiving or engaging surface 21 or 23 may provide a button cavity 41 dimensioned and adapted to receive the other instrument's strap button 38 in the nested condition. The button cavity 41 may provide a supportive material 40 sized and dimensioned snugly engage the strap button 38 received within the button cavity 41. In certain embodiments, the supportive material may be tubular, as illustrated in FIG. 6, much like one of the rigid material 24 embodiments.

In the embodiments wherein the host and satellite instruments 10 and 12 are electric guitars, the host instrument 10 may be larger and mounted in the nested condition to the satellite instrument 12 along the host's lower (relative to the way guitars are typically played) peripheral edge. Each such electrical instruments would have the necessary equipment, including but not limited to potentiometers 42, 44, jacks 46, strings 48, electromagnetic pickups 50 and the like.

Related to the process of making the present invention, a first consideration when making a magnetic double neck guitar is the shape of the two guitar bodies where they are to join at the receiving and engaging surfaces 21, 23 in a complimentary and tight-fitting engagement. The magnet 14 and its corresponding ferromagnetic element 18 must be mounted directly across from each other, each flush with its corresponding receiving and engaging surfaces 21 and 23, so as to ensure a tight nested condition.

A method of using the present invention may include the following. The modular double neck electric instrument 100 disclosed above may be provided. A user may wear the host instrument 10 with a strap, and plug the host instrument 10 into an amplifier as normal. Grasping the neck of the host instrument 10 with his/her playing/picking hand, and the satellite instrument 12 with his/her fretting hand, the user can align, in certain embodiments, the satellite instrument's pin(s) 22 into the host instrument's lower pin cavity(ies) 25, while the magnet 14 and ferromagnetic element 16 magnetically couple the two instruments into the nested condition. As a result of such nested condition, the electrical connection happens automatically by way of the spring loaded first conductor 28 and the second conductor 34 as the two instruments connect. Then the user can flip a switch on the host instrument 10 to decide which instrument (or both) is amplified, as the two instruments are electrically connected.

Alternatively, the user may easily separate the two instruments to the separate condition pulling them apart with no need of tools to manipulate fasteners, thereby quickly enabling the user to separately play either the host or satellite instrument, as the musical arrangement calls for, even during the same song.

It should be understood, of course, that the foregoing relates to exemplary embodiments of the invention and that modifications may be made without departing from the spirit and scope of the present invention.

What is claimed is:

1. A device, comprising:
a host musical instrument having a host body, the host body forming a receiving surface along a portion of its periphery;
a satellite musical instrument having a satellite body, the satellite body forming an engaging surface along a portion of its periphery, wherein the engaging surface complements the receiving surface so as to interface in a nested condition;
a physical connection comprising:
a lateral connection; and
an axial connection spaced apart from the lateral connection, wherein the physical connection is provided along the receiving and the engaging surface; and
an electrical connection provided along both the receiving and the engaging surface so as to not protrude from either surface in the nested condition,
whereby the host musical instrument and the satellite musical instrument are movable between the nested condition and a separate condition without tools, and in each condition the musical instruments are musically playable.

2. The device of claim 1, wherein the receiving and engaging surfaces are complementary concave and convex J-shapes, respectively.

3. The device of claim 1, wherein the axial connection comprises a magnet and a ferromagnetic element, each disposed on opposing surfaces of the receiving and engaging surface and aligned in the nested condition.

4. The device of claim 1, wherein the lateral connection comprises at least one pin and at least one complementary pin cavity, each disposed on opposing surfaces of the receiving and engaging surface and aligned in the nested condition.

5. The device of claim 1, wherein electrical connection comprises:
at least one first conductor spring loaded in a receptacle to protrude therefrom; and
at least one complementary second conductor,
wherein each first and complementary second conductors is disposed on opposing surfaces of the receiving and engaging surface, aligned, and electrically connected in the nested condition.

6. The device of claim 1, further comprising:
a strap button provided on the engaging surface; and
a button cavity provided on the receiving surface so as to operatively align with the strap button in the nested condition.

7. A device, comprising:
a host musical instrument having a host body, the host body forming a receiving surface along a portion of its periphery, wherein the receiving and engaging surfaces are complementary concave and convex J-shapes, respectively;
a satellite musical instrument having a satellite body, the satellite body forming an engaging surface along a portion of its periphery, wherein the engaging surface complements the receiving surface so as to interface in a nested condition;
a physical connection comprising:
a lateral connection comprising least one pin and at least one complementary pin cavity, each disposed on opposing surfaces of the receiving and engaging surface and aligned in the nested condition; and
an axial connection spaced apart from the lateral connection, wherein the physical connection is provided along the receiving and the engaging surface, the axial connection including a magnet and a ferromagnetic element, each disposed on opposing surfaces of the receiving and engaging surface and aligned in the nested condition;
an electrical connection provided along both the receiving and the engaging surface so as to not protrude from either surface in the nested condition, the electrical connection including:
at least one first conductor spring loaded in a receptacle to protrude therefrom; and
at least one complementary second conductor, wherein each first and complementary second conductors is disposed on opposing surfaces of the receiving and engaging surface, aligned, and electrically connected in the nested condition;
a strap button provided on the engaging surface; and
a button cavity provided on the receiving surface so as to operatively align with the strap button in the nested condition,
whereby the host musical instrument and the satellite musical instrument are movable between the nested condition and a separate condition without tools, and in each condition the musical instruments are musically playable.
